(19) United States
(12) Patent Application Publication
(10) Pub. No.: US 2019/0200234 A1
(43) Pub. Date: Jun. 27, 2019

(54) Signaling Attack Prevention Method and Apparatus

(71) Applicant: Huawei Technologies Co., Ltd., Shenzhen (CN)

(72) Inventor: Chengdong He, Shenzhen (CN)

(21) Appl. No.: 16/289,120

(22) Filed: Feb. 28, 2019

Related U.S. Application Data
(63) Continuation of application No. PCT/CN2017/080384, filed on Apr. 13, 2017.

(30) Foreign Application Priority Data
Aug. 31, 2016 (CN) 201610794941.6

(51) Int. Cl. H04W 12/12; H04L 29/06; H04W 12/08

(52) U.S. Cl. CPC H04W 12/1204; H04L 63/029; H04L 63/123; H04L 63/0236; H04W 12/0808

(57) ABSTRACT

A signaling attack prevention method and apparatus, where the method includes receiving a general packet radio service (GPRS) Tunneling Protocol (GTP-C) message from a public data network gateway (PGW), determining whether the GTP-C message is received from an S8 interface, determining whether a characteristic parameter of the GTP-C message is valid when the GTP-C message is received from the S8 interface, and discarding the GTP-C message or returning, to the PGW, a GTP-C response message carrying an error code cause value when the characteristic parameter of the GTP-C message is invalid. By determining validity of each parameter in the GTP-C message, a hacker is effectively prevented from attacking a serving gateway (SGW) using each attack path, and communication security is improved.

### CROSS-REFERENCE TO RELATED APPLICATIONS

This application is a continuation of International Patent Application No. PCT/CN2017/080384 filed on Apr. 13, 2017, which claims priority to Chinese Patent Application No. 201610794941.6 filed on Aug. 31, 2016. The disclosures of the aforementioned applications are hereby incorporated by reference in their entireties.

### TECHNICAL FIELD

The present disclosure relates to the communications field, and in particular, to a signaling attack prevention method and apparatus.

### BACKGROUND

Both a serving gateway (SGW) and a public data network gateway (PGW) are important network elements in a mobile communications network. The SGW is responsible for a data plane function such as user data forwarding. The PGW provides functions such as user session management and bearer control, data forwarding, Internet Protocol (IP) address assignment, and non-3rd Generation Partnership Project (3GPP) user access.

In a network in the 4th generation mobile communication technology (4G), the SGW and the PGW communicate with each other based on a fifth data interface (S5) or an eighth data interface (S8) defined in the GTP-C protocol in the general packet radio service (GPRS) Tunneling Protocol (GTP). When the SGW and the PGW belong to a same operator, the SGW and the PGW communicate with each other using the S5 interface, and in this case, the communication is secure. However, when the SGW and the PGW belong to different operators, the SGW and the PGW communicate with each other using the S8 interface, and in this case, a hacker may attack the SGW using the PGW, resulting in a communication security risk.

### SUMMARY

Embodiments of the present disclosure provide a signaling attack prevention method and apparatus to prevent a GTP-C signaling attack and improve communication security.

According to a first aspect, an embodiment of the present disclosure provides a signaling attack prevention method. The method includes receiving, by an SGW or an edge node, a GTP-C message sent by a PGW, determining, by the SGW or the edge node, whether the GTP-C message is received from an S8 interface, when the GTP-C message is received from the S8 interface, determining, by the SGW or the edge node, whether a characteristic parameter of the GTP-C message is valid, and if the characteristic parameter of the GTP-C message is invalid, discarding, by the SGW or the edge node, the GTP-C message or returning, to the PGW, a GTP-C response message carrying an error code cause value.

In the solution provided in this embodiment of the present disclosure, validity of each parameter in the GTP-C message is determined, and when each characteristic parameter is invalid, the GTP-C message is discarded or the GTP-C response message carrying the error code cause value is returned to the PGW such that a hacker can be effectively prevented from attacking the SGW using each attack path, and communication security is improved.

In a possible design, the determining, by the SGW or the edge node, whether the GTP-C message is received from an S8 interface includes determining, by the SGW or the edge node, whether the source IP address and an IP address of the SGW or the edge node that receives the GTP-C message belong to a same network segment, and when the source IP address and the IP address of the SGW or the edge node that receives the GTP-C message do not belong to a same network segment, determining, by the SGW or the edge node, that an interface for receiving the GTP-C message is the S8 interface.

In a possible design, determining, by the SGW or the edge node, whether the GTP-C message is received from an S8 interface includes determining, by the SGW or the edge node, whether the source IP address belongs to an IP address set authorized by an operator to which the SGW or the edge node belongs, and when the source IP address does not belong to the IP address set authorized by the operator to which the SGW or the edge node belongs, determining, by the SGW or the edge node, that an interface for receiving the GTP-C message is the S8 interface.

In the solution provided in this embodiment of the present disclosure, by means of determining whether the GTP-C message is received from the S8 interface, attack prevention processing may be performed only on the GTP-C message received by the SGW or the edge node from the S8 interface such that attack prevention efficiency is improved.

In a possible design, the characteristic parameter includes a message type of the GTP-C message, and determining, by the SGW or the edge node, whether a characteristic parameter of the GTP-C message is valid includes determining, by the SGW or the edge node, whether the message type of the GTP-C message is an S11 interface message type, and when the message type of the GTP-C message is the S11 interface message type, determining, by the SGW or the edge node, that the message type of the GTP-C message is invalid. By means of further determining validity of the message type of the GTP-C message, the hacker can be further prevented from performing signaling attack on the SGW using the GTP-C message, and communication security is improved.

In a possible design, the characteristic parameter includes a source IP address in the GTP-C message, and determining, by the SGW or the edge node, whether a characteristic parameter of the GTP-C message is valid includes determining, by the SGW or the edge node, whether the source IP address belongs to a preset IP address set, and when the source IP address does not belong to the preset IP address set, determining, by the SGW or the edge node, that the source IP address in the GTP-C message is invalid. By means of presetting a valid IP address set and determining whether the source IP address in the GTP-C message is in the IP address set, the hacker can be further prevented from launching a signaling attack on the SGW by forging the IP address in the GTP-C message, and communication security is improved.

In a possible design, the characteristic parameter includes the source IP address in the GTP-C message, and the determining, by the SGW or the edge node, whether a characteristic parameter of the GTP-C message is valid includes sending, by the SGW or the edge node, the source IP address to a home subscriber server (HSS) and/or a mobility management entity (MME) such that the MME and/or the HSS determine/determines whether the source IP address belongs to the preset IP address set, receiving, by the SGW or the edge node, a home operator determining result returned by the MME and/or the HSS, and when the home operator determining result is that the source IP address does not belong to the preset IP address set, determining that the source IP address in the GTP-C message is invalid. By means of presetting the valid IP address set in the HSS or the MME and determining whether the source IP address in the GTP-C message is in the IP address set, the hacker can be further prevented from launching a signaling attack on the SGW by forging the IP address in the GTP-C message, and communication security is improved.

In a possible design, the characteristic parameter includes the source IP address in the GTP-C message, and determining, by the SGW or the edge node, whether a characteristic parameter of the GTP-C message is valid further includes determining, by the SGW or the edge node, whether the source IP address is consistent with a source IP address in a GTP-C message received by the SGW or the edge node before the GTP-C message is received, and when the source IP address is inconsistent with the source IP address in the GTP-C message received by the SGW or the edge node before the GTP-C message is received, determining, by the SGW or the edge node, that the source IP address in the GTP-C message is invalid. By means of determining consistency of the source IP address in the GTP-C message, the hacker can be further prevented from launching a signaling attack on the SGW by forging the IP address in the GTP-C message, and communication security is improved.

In a possible design, the characteristic parameter includes an international mobile subscriber identity (IMSI) of a user, and determining, by the SGW or the edge node, whether a characteristic parameter of the GTP-C message is valid includes determining, by the SGW or the edge node, whether the IMSI is an IMSI authorized by an operator to which the PGW belongs, and when the IMSI is not the IMSI authorized by the operator to which the PGW belongs, determining, by the SGW or the edge node, that the IMSI in the GTP-C message is invalid. Because the IMSI is an identity of a terminal user that sends the GTP-C message using the PGW, that is, a message resource that sends the GTP-C message, whether the GTP-C is sent by a valid terminal user can be accurately determined using the IMSI in the GTP-C message to determine validity of the GTP-C message in order to prevent the hacker from launching a malicious attack on the SGW using GTP-C signaling, and improve communication security.

In an example, the IMSI is carried in the GTP-C message or is obtained using a tunnel endpoint identifier (TEID) carried in the GTP-C message. Because the GTP-C message may carry the IMSI or may carry the TEID, when the GTP-C message carries the TEID, the IMSI may be found using the TEID.

According to a second aspect, an embodiment of the present disclosure provides a signaling attack prevention apparatus. The signaling attack prevention apparatus has a function of implementing the first aspect, and the function may be implemented using hardware, or may be implemented using hardware to execute corresponding software. The hardware or the software includes one or more modules corresponding to the foregoing function.

In a possible design, the signaling attack prevention apparatus may include an SGW.

In a possible design, the signaling attack prevention apparatus may include an edge node.

According to a third aspect, an embodiment of the present disclosure provides a signaling attack prevention apparatus. The signaling attack prevention apparatus includes a processor, a receiver, and a transmitter. The processor is configured to support a terminal in executing a corresponding function in the foregoing method. The receiver and the transmitter are configured to support the signaling attack prevention apparatus in communicating with a PGW. Further, a relay device may further include a memory, the memory is configured to couple with the processor, and the memory stores a program instruction and data that are necessary to the terminal.

According to a fourth aspect, an embodiment of the present disclosure provides a computer storage medium configured to store a computer software instruction used by the signaling attack prevention apparatus in the second aspect, and the computer storage medium includes a program designed for executing the foregoing aspect.

In comparison with the other approaches, in the solutions provided in the embodiments of the present disclosure, after the SGW or the edge node receives the GTP-C message sent by the PGW, whether the characteristic parameter carried in the GTP-C message is valid is determined when the GTP-C message is received from the S8 interface, and the GTP-C message is discarded or the GTP-C response message carrying the error code cause value is returned to the PGW when the characteristic parameter is invalid such that a hacker can be effectively prevented from attacking the SGW using each attack path, and communication security is improved.

### BRIEF DESCRIPTION OF DRAWINGS

To describe the technical solutions in some of the embodiments of the present disclosure more clearly, the following briefly describes the accompanying drawings describing the embodiments. The accompanying drawings in the following description show merely some embodiments of the present disclosure, and persons of ordinary skill in the art may still derive other drawings from these accompanying drawings without creative efforts.

FIG. 1 is a diagram of a network architecture used for communication between an SGW and a PGW according to an embodiment of the present disclosure;

FIG. 2 is a schematic diagram of a signaling attack according to an embodiment of the present disclosure;

FIG. 3 is a diagram of an S8 interface protocol stack according to an embodiment of the present disclosure;

FIG. 4 is a schematic flowchart of a signaling attack prevention method according to an embodiment of the present disclosure;

FIG. 5 is a schematic flowchart of another signaling attack prevention method according to an embodiment of the present disclosure;

FIG. 6 is a schematic structural diagram of a signaling attack prevention apparatus according to an embodiment of the present disclosure; and

FIG. 7 is a schematic structural diagram of another signaling attack prevention apparatus according to an embodiment of the present disclosure.

### DESCRIPTION OF EMBODIMENTS

Embodiments of the present disclosure provide a signaling attack prevention method and apparatus, to prevent a GTP-C signaling attack and improve communication security.

To make persons skilled in the art better understand the technical solutions in the present disclosure, the following clearly describes the technical solutions in the embodiments of the present disclosure with reference to the accompanying drawings in the embodiments of the present disclosure. The described embodiments are merely some of rather than all of the embodiments of the present disclosure. All other embodiments obtained by persons of ordinary skill in the art based on the embodiments of the present disclosure without creative efforts shall fall within the protection scope of the present disclosure.

In the specification, claims, and accompanying drawings of the present disclosure, the terms “first,” “second,” “third,” and so on are intended to distinguish between different objects but do not indicate a particular order. In addition, the terms “including” or any other variant thereof, are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

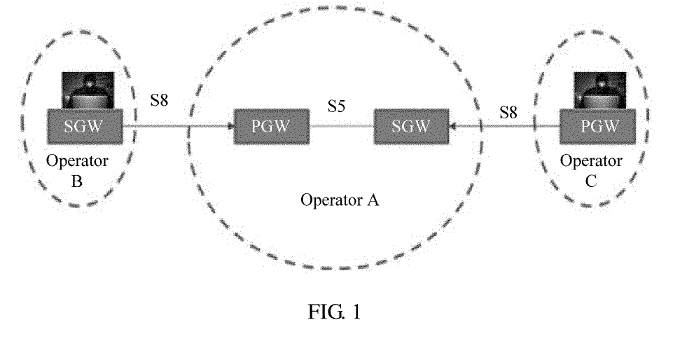

Referring to FIG. 1, FIG. 1 is a diagram of a network architecture used for communication between an SGW and a PGW according to an embodiment of the present disclosure. As shown in FIG. 1, when an SGW and a PGW belong to a same operator, an interface between the SGW and the PGW is referred to as an S5 interface. When the SGW and the PGW belong to different operators, an interface between the SGW and the PGW is referred to as an S8 interface.

In this embodiment of the present disclosure, if the SGW and the PGW communicate with each other using the S8 interface, the following conditions need to be met. 1. An operator to which the SGW belongs and an operator to which the PGW belongs need to sign a roaming agreement. 2. An IMSI in a message sent by the SGW to the PGW needs to belong to the operator to which the PGW belongs, and the user has a roaming access permission in a network of the operator to which the SGW belongs.

When the SGW and the PGW belong to different operators, in this case, the SGW and the PGW belong to different security domains. Therefore, a peer network element may be attacked using the S8 interface.

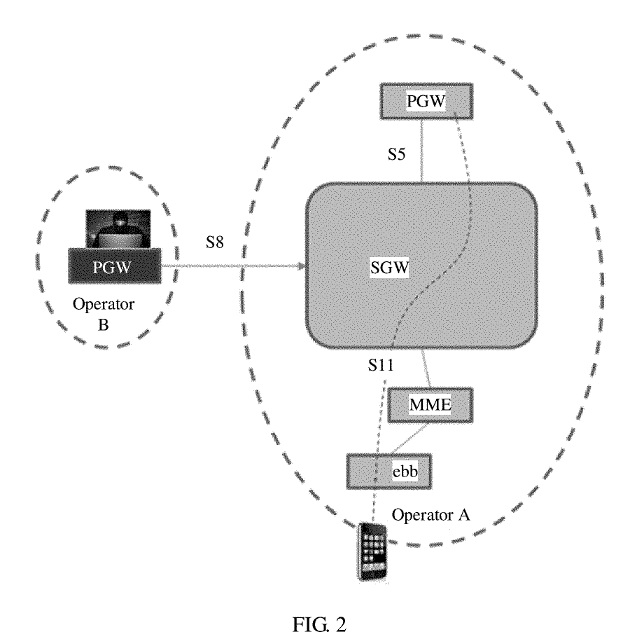

Referring to FIG. 2, FIG. 2 is a schematic diagram of a signaling attack according to an embodiment of the present disclosure. In a network architecture shown in FIG. 2, a PGW of an operator B may attack an SGW of an operator A using an S8 interface as described below.

1. An attack path 1: A hacker uses the PGW of the operator B to send a create bearer request message to the SGW of the operator A using the S8 interface, an IMSI parameter is an IMSI of a terminal attached to the operator B, and the SGW returns a response message to indicate that bearer creation succeeds.

Consequently, a security risk may be caused: An attacker may repeatedly perform the foregoing attack, until a maximum dedicated bearer quantity of a terminal user is reached. In this case, when the terminal user executes a normal dedicated bearer creation procedure later, because the maximum dedicated bearer quantity is reached, the normal dedicated bearer creation procedure fails, and the user cannot normally use a network service.

2. An attack path 2: A hacker uses the PGW of the operator B to send a delete session request message to the SGW of the operator A using the S8 interface, an IMSI parameter is an IMSI of a terminal attached to the operator B, and the SGW returns a response message to indicate that dedicated session deletion succeeds. Consequently, a security risk 2 may be caused: An attached user is forced to exit a network.

3. An attack path 3: A hacker uses the PGW of the operator B to send a delete bearer request message to the SGW of the operator A using the S8 interface, an IMSI parameter is an IMSI of a user terminal attached to the operator B, and the SGW returns a response message to indicate that dedicated bearer deletion succeeds. Consequently, a security risk 3 may be caused: Because the dedicated bearer is deleted, a user cannot normally use a network service corresponding to the dedicated bearer.

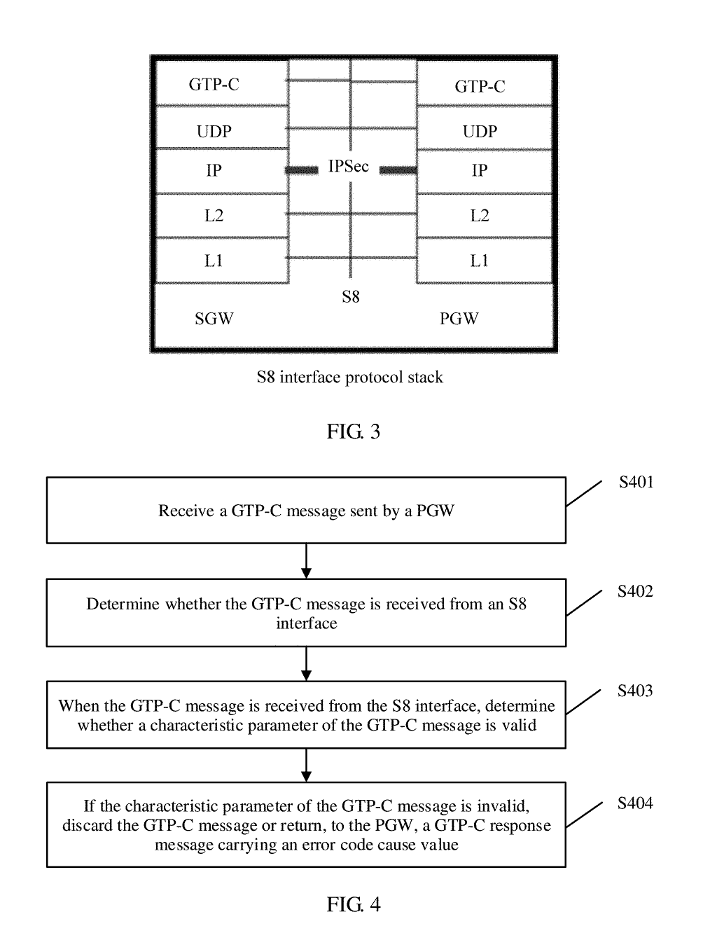

In this embodiment of the present disclosure, to ensure signaling security on the S8 interface, the IP Security (IPSec) IP address Sec is deployed on the S8 interface to protect GTP-C signaling security on the S8 interface, for example, identity authentication between the SGW and the PGW, and integrity and confidentiality of data above an IP address layer. Referring to FIG. 3, FIG. 3 is a diagram of an S8 interface protocol stack according to an embodiment of the present disclosure. However, because all the foregoing three attacks belong to attacks in a GTP-C signaling plane above the IP address layer, even if the identity authentication between the PGW and the SGW succeeds, and the integrity and the confidentiality of the data above the IP address layer are ensured, the attacker may still launch an attack by sending normal GTP-C signaling. Therefore, a conventional IP address Sec mechanism cannot prevent such an attack, and protection for an application plane (such as a GTP-C plane) above the IP address layer needs to be considered.

Referring to FIG. 4, FIG. 4 is a schematic flowchart of an embodiment of a signaling attack prevention method according to an embodiment of the present disclosure. As shown in FIG. 4, the method may include the following steps.

Step S401. Receive a GTP-C message sent by a PGW.

In this embodiment of the present disclosure, the GTP-C message sent by the PGW may be received by an SGW, or the GTP-C message sent by the PGW may be received by an edge node (GTP-C aware).

Optionally, the edge node may be a firewall that is deployed at a border of an operator network and that is aware of the GTP-C Protocol.

Further, in this embodiment of the present disclosure, the GTP-C message may be a create bearer request message, a delete session request message, a delete bearer request message, or the like.

Optionally, the GTP-C message may include at least one of a source IP address in the GTP-C message, an IMSI of a user, or a message type of the GTP-C message.

Step S402. Determine whether the GTP-C message is received from an S8 interface.

In this embodiment of the present disclosure, when attacking an SGW of an operator A using a PGW of an operator B, a hacker sends a GTP-C attack message using the S8 interface. Therefore, to prevent the foregoing attacks, only validity of the GTP-C message received from the S8 interface needs to be determined, and security of a message received from an S5 interface or another security interface does not need to be determined.

Optionally, determining whether the GTP-C message is received from an S8 interface includes determining whether the source IP address in the GTP-C message and an IP address of the SGW or the edge node that receives the GTP-C message belong to a same network segment, and when the source IP address and the IP address of the SGW or the edge node that receives the GTP-C message do not belong to a same network segment, determining that an interface for receiving the GTP-C message is the S8 interface.

Optionally, determining whether the GTP-C message is received from an S8 interface includes determining whether the source IP address in the GTP-C message belongs to an IP address set authorized by an operator to which the SGW or the edge node belongs, and when the source IP address does not belong to the IP address set authorized by the operator to which the SGW or the edge node belongs, determining that an interface for receiving the GTP-C message is the S8 interface.

Further, the IP address set may be stored in the SGW or the edge node.

For example, in an example of the present disclosure, if the SGW belongs to the operator B, the IP address set is a set of all IP addresses authorized and supported by the operator B.

Further, the IP address set may be all independent IP addresses such as an IP address 192.168.6.28 and an IP address 192.168.6.78, or may be an IP address segment, for example, 192.168.6.0 is used to indicate an IP address segment from 192.168.6.0 to 192.168.6.255.

It may be understood that, by means of determining whether the GTP-C message is received from the S8 interface, attack prevention processing may be performed only on the GTP-C received by the SGW or the edge node from the S8 interface such that attack prevention efficiency is improved.

Step S403. When the GTP-C message is received from the S8 interface, determine whether a characteristic parameter of the GTP-C message is valid.

Step S404. If the characteristic parameter of the GTP-C message is invalid, discard the GTP-C message or return, to the PGW, a GTP-C response message carrying an error code cause value.

The error code cause value is a value used to reflect an invalidity type of the characteristic parameter of the GTP-C message. For example, when an IMSI parameter carried in the GTP-C message is invalid, an error code cause value is carried in the GTP-C response message to indicate that the IMSI parameter is invalid, or when a source IP parameter in the GTP-C message is invalid, another error code cause value may be carried in the GTP-C response message to indicate that the source IP parameter is invalid.

Optionally, if the characteristic parameter of the GTP-C message is valid, in this case, it indicates that the GTP-C message is valid. Therefore, in this case, normal service processing may be continued.

It can be learned that, in the solution in this embodiment, after the SGW or the edge node receives the GTP-C message sent by the PGW, whether the characteristic parameter carried in the GTP-C message is valid is determined when the GTP-C message is received from the S8 interface, and the GTP-C message is discarded or the GTP-C response message carrying the error code cause value is returned to the PGW when the characteristic parameter is invalid such that a hacker can be effectively prevented from attacking the SGW using each attack path, and communication security is improved.

Optionally, in an embodiment of the present disclosure, the characteristic parameter includes the message type of the GTP-C message.

Determining whether a characteristic parameter of the GTP-C message is valid includes determining whether the message type of the GTP-C message is an S11 interface message type, and when the message type of the GTP-C message is the S11 interface message type, determining that the message type of the GTP-C message is invalid.

The message type is a type of the received GTP-C message. In this embodiment of the present disclosure, the message type of the GTP-C message may be a message type such as a create/delete session request (IMSI, . . . ) or a create/delete bearer request (TEID, . . . ). The S11 interface message type is a message type of a GTP-C message received by the SGW or the edge node using an S11 interface when the SGW and the PGW normally communicate with each other.

For example, in this embodiment of the present disclosure, when the SGW and the PGW normally communicate with each other, an S8 interface message such as a create/delete bearer request (TEID, . . . ) is received using an S8 interface, and an S11 interface message such as a create/delete session request (IMSI, . . . ) is received using an S11 interface. In this case, a message type of the S11 interface message such as the create/delete session request (IMSI, . . . ) received using the S11 interface may be defined as an S11 interface message type. When the S11 interface message such as the create/delete session request (IMSI, . . . ) is received using the S8 interface, because this type of message should be received using the S11 interface in normal communication, in this case, it may be determined that the message type of the GTP-C message is invalid.

Further, because a hacker may simulate another network element (such as an MME) on the S8 interface to send a GTP-C message of the S11 interface type to attack the SGW to ensure communication security, in this case, the message is discarded, or further, a GTP-C response message carrying an error code may be sent to the PGW.

Optionally, when the GTP-C message type is not the S11 interface message type (that is, the GTP-C message type is an S5/S8 interface message type), in this case, it indicates that the message type of the GTP-C message is valid, and normal service processing may be continued.

It may be understood that, validity of the GTP-C message may be further determined by determining whether the message type is the S11 interface message type.

Optionally, in some embodiments of the present disclosure, the characteristic parameter includes the source IP address in the GTP-C message.

Determining whether a characteristic parameter of the GTP-C message is valid includes determining whether the source IP address belongs to a preset IP address set, and when the IP address does not belong to the preset IP address set, determining that the source IP address in the GTP-C message is invalid.

Optionally, when the IP address belongs to the preset IP address set, it is determined that the source IP address in the GTP-C message is valid.

The preset IP address set is an IP address set authorized by a roaming operator permitted by the operator to which the SGW belongs.

Further, the preset IP address set may be pre-configured in the SGW or the edge node.

Further, a list of roaming operators (peer PGW IP addresses or peer public land mobile network (PLMN) identifiers (also referred to as IDs) permitted by the operator to which the SGW belongs may be configured in the SGW or the edge node. Then, whether the source IP address is in the list is determined.

Further, the IP address set may be all independent IP addresses such as an IP address 192.168.6.28 and an IP address 192.168.6.78, or may be an IP address segment, for example, 192.168.6.0 is used to indicate an IP address segment from 192.168.6.0 to 192.168.6.255.

Optionally, in some other embodiments of the present disclosure, the characteristic parameter includes the source IP address in the GTP-C message.

Determining whether a characteristic parameter of the GTP-C message is valid includes sending the source IP address to an HSS and/or an MME such that the MME and/or the HSS determine/determines whether the source IP address belongs to the preset IP address set, receiving a home operator determining result returned by the MME and/or the HSS, and when the home operator determining result is that the source IP address does not belong to the preset IP address set, determining that the source IP address in the GTP-C message is invalid.

Optionally, when the home operator determining result is that the source IP address belongs to the preset IP address set, it is determined that the source IP address in the GTP-C message is valid.

The home operator determining result is a result obtained after the MME and/or the HSS determine/determines whether the IP address in the GTP-C message is in the preset IP address set.

Further, the preset IP address set may be pre-configured in the HSS or the MME.

Further, a list of roaming operators (peer PGW IP addresses or peer PLMN IDs) permitted by the operator to which the SGW belongs may be configured in the HSS or the MME, the SGW or the edge node sends the source IP address to the HSS or the MME, and then the HSS or the MME determines whether the source IP address is in the list to obtain a home operator determining result, and returns the home operator determining result to the SGW or the edge node. When the home operator determining result is that the source IP address does not belong to the preset IP address set, it is determined that the source IP address in the GTP-C message is invalid.

It may be understood that the attack prevention method is more flexible by determining, in different manners, whether the source IP address is valid.

It may be understood that, because the source IP address in the GTP-C message can reflect the operator of the peer PGW, whether the peer PGW is in the list of the permitted roaming operators may be determined using the source IP address in order to determine that the GTP-C message is invalid when the peer PGW is not in the list of the permitted roaming operators, that is, the GTP-C message may be from a hacker attack. In this case, to ensure communication security, the message is discarded, or further, the GTP-C response message carrying the error code may be sent to the PGW.

Optionally, whether the operator to which the PGW belongs is a roaming operator permitted by the SGW may be determined using another parameter that can reflect a network code of the GTP-C message.

Further, optionally, an information list of permitted roaming operators may be pre-configured in the SGW or the edge node (GTP-C aware). The information list of the roaming operators includes an IP address of a peer PGW sending the GTP-C message and a PLMN ID of the peer PGW. Then, whether the source IP address or the PLMN ID or both that are in the GTP-C message and that are of the PGW are in the information list of the roaming operators is checked. If the source IP address or the PLMN ID or both of the PGW belong to the information list of the roaming operators, it is determined that the operator to which the PGW belongs is an operator authorized by the SGW, or if the source IP address or the PLMN ID or both of the PGW do not belong to the information list of the roaming operators, it is determined that the operator to which the PGW belongs is not an operator authorized by the SGW, that is, the GTP-C message may be from a hacker attack. In this case, to ensure communication security, the message is discarded, or further, the GTP-C response message carrying the error code may be sent to the PGW.

Alternatively, an information list of permitted roaming operators may be pre-configured in the HSS and/or the MME. The information list of the roaming operators includes an IP address of a peer PGW sending the GTP-C message and a PLMN ID of the peer PGW. Then, the SGW or the edge node (GTP-C aware) sends the source IP address and/or the PLMN ID of the peer PGW to the HSS and/or the MME. The HSS or the MME or both determine whether the source IP address or the PLMN ID or both are in the information list of the roaming operators to obtain a home operator determining result, and return the result to the SGW or the edge node. If the source IP address or the PLMN ID or both of the PGW are in the information list of the roaming operators, it is determined that the operator to which the PGW belongs is an operator authorized by the SGW, or if the source IP address or the PLMN ID or both of the PGW do not belong to the information list of the roaming operators, it is determined that the operator to which the PGW belongs is not an operator authorized by the SGW, that is, the GTP-C message may be from a hacker attack. In this case, to ensure communication security, the message is discarded, or further, the GTP-C response message carrying the error code may be sent to the PGW.

It may be understood that, because the IP address and/or the PLMN ID of the PGW can reflect the operator to which the PGW belongs, whether the operator to which the PGW belongs is a roaming operator permitted by the SGW may be determined using the IP address and/or the PLMN ID of the PGW in order to further determine whether the message is valid.

Optionally, in an embodiment of the present disclosure, the characteristic parameter includes the source IP address in the GTP-C message.

Determining whether a characteristic parameter of the GTP-C message is valid further includes determining whether the source IP address is consistent with a source IP address in a GTP-C message received by the SGW or the edge node before the GTP-C message is received, and when the source IP address is inconsistent with the source IP address in the GTP-C message received by the SGW or the edge node before the GTP-C message is received, determining that the source IP address in the GTP-C message is invalid.

Determining whether the source IP address is consistent with a source IP address in a GTP-C message received by the SGW or the edge node before the GTP-C message is received includes determining whether the source IP address is consistent with the source IP address in a create session response message in the GTP-C message received by the SGW or the edge node before the GTP-C message is received.

Further, optionally, the SGW detects whether the PGW IP address (an IP address parameter of an s5s8-pgw-gtpu-interface of an s5s8-u-pgw-f-teid, or a source IP address parameter of an IP address layer) in the message is consistent with the PGW IP address (an IP address parameter of an s5s8-pgw-gtpu-interface of an s5s8-u-pgw-f-teid, or a source IP address parameter of an IP address layer) in the create session response message previously received from the PGW, and determines that the GTP-C message is valid when the PGW IP address is consistent with the PGW IP address in the create session response message previously received from the PGW. In this case, normal service processing may be continued. When the PGW IP address is inconsistent with the PGW IP address in the create session response message previously received from the PGW, it is determined that the GTP-C message is invalid, that is, the GTP-C message may be from a hacker attack. In this case, to ensure communication security, the message is discarded, or further, the GTP-C response message carrying the error code may be sent to the PGW.

Optionally, validity of the GTP-C message may be further determined by determining whether the source IP address or the PLMN ID or both are consistent with a source IP address or a PLMN ID or both in the GTP-C message received by the SGW or the edge node before the GTP-C message is received.

It may be understood that, IP addresses in GTP-C messages sent by a same PGW are consistent. Therefore, by further determining whether the PGW IP address in the currently received GTP-C message is consistent with the PGW IP address in the GTP-C message previously received from the PGW, validity of the GTP-C message can be further ensured, and communication security is ensured.

Optionally, in an embodiment of the present disclosure, the characteristic parameter includes the IMSI of the user.

Determining whether a characteristic parameter of the GTP-C message is valid includes determining whether the IMSI is an IMSI authorized by an operator to which the PGW belongs, and when the IMSI is not the IMSI authorized by the operator to which the PGW belongs, determining that the IMSI in the GTP-C message is invalid.

Optionally, when the IMSI is the IMSI authorized by the operator to which the PGW belongs, it is determined that the GTP-C message is valid.

The IMSI is an identity used to uniquely identify a terminal user that sends the GTP-C message using the PGW.

Further, because the GTP-C message directly carries the IMSI, or carries a TEID, the IMSI is carried in the GTP-C message or is obtained using the TEID carried in the GTP-C message.

Optionally, the GTP-C message may include another identity used to uniquely identify the terminal user that sends the GTP-C message using the PGW.

Further, the SGW or the edge node checks whether a mobile country code (MCC) or a mobile network code (MNC) or both in the IMSI are consistent with an MCC and/or an MNC to which the SGW belongs in order to determine whether the IMSI is valid.

Further, a list of MCCs and/or MNCs to which the PGW belong/belongs may be pre-configured in the SGW or the edge node, and then whether the MCC or the MNC or both in the IMSI in the GTP-C message are in the list is checked to determine whether the IMSI is valid.

MCC resources are centrally allocated and managed by the International Telecommunication Union (ITU). An MCC uniquely identifies a country to which a mobile subscriber belongs, and includes three digits, which are 460 for China. An MNC is used to identify a mobile network to which a mobile client belongs. For example, MNCs of China Mobile are 00, 02, 04, and 07, MNCs of China Unicom are 01 and 06, and MNCs of China Telecom are 03 and 05.

It may be understood that, because the IMSI is the identity of the terminal user that sends the GTP-C message using the PGW, that is, a message resource that sends the GTP-C message, whether the GTP-C is sent by a valid terminal user can be accurately determined using the IMSI in the GTP-C message to determine validity of the GTP-C message in order to prevent a hacker from launching a malicious attack using GTP-C signaling, and improve communication security.

It should be noted that, the embodiment of the present disclosure includes determining 1: determining whether the source IP address in the GTP-C message is valid, to determine whether the peer PGW is in the list of the roaming operators permitted by the operator to which the SGW belongs; determining 2: determining whether the source IP address in the GTP-C message is valid, to determine consistency of the GTP-C message; determining 3: determining whether the message type of the GTP-C message is valid; and determining 4: determining whether the IMSI in the GTP-C message is valid. Execution of the determining is not strictly limited, and all embodiments in which the foregoing determining steps are performed are optional embodiments of the present disclosure.

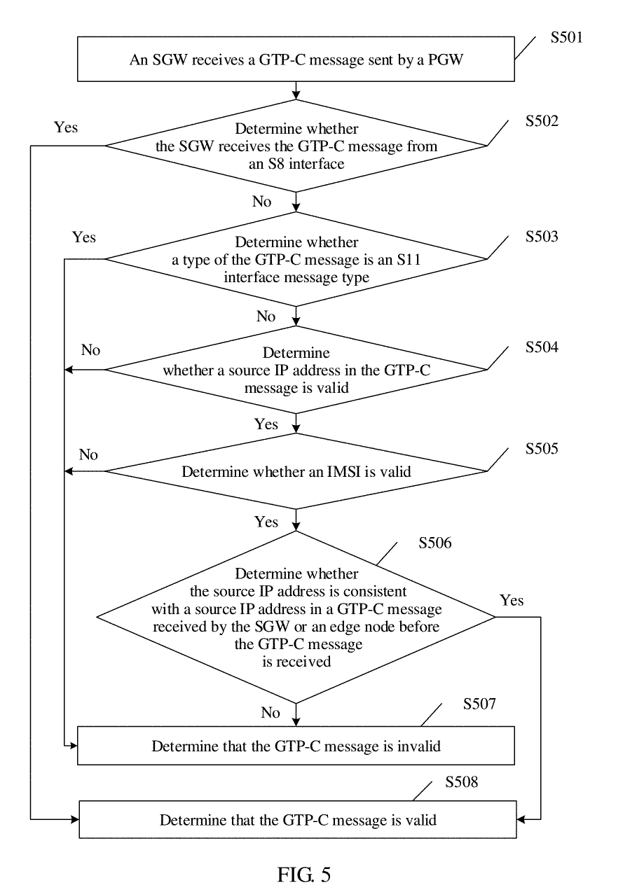

To better understand and implement the foregoing solutions in the embodiments of the present disclosure, the following further describes the embodiments of the present disclosure with reference to FIG. 5.

Referring to FIG. 5, FIG. 5 is a schematic flowchart of another signaling attack prevention method according to an embodiment of the present disclosure. In the method shown in FIG. 5, for content that is the same as or similar to that in the method shown in FIG. 4, refer to detailed descriptions in FIG. 4, and details are not described herein again. As shown in FIG. 5, the method may include the following steps.

Step S501. An SGW receives a GTP-C message sent by a PGW.

The GTP-C message includes a source IP address of the peer PGW, and an IMSI of a user sending the GTP-C message.

Step S502. Determine whether the SGW receives the GTP-C message from an S8 interface.

Optionally, if the SGW receives the GTP-C message from the S8 interface, in this case, step S508 is performed.

Optionally, if the SGW does not receive the GTP-C message from the S8 interface, in this case, step S503 is performed.

Step S503. Determine whether a type of the GTP-C message is an S11 interface message type.

Optionally, if the type of the GTP-C message is the S11 interface message type, in this case, step S507 is performed.

Optionally, if the type of the GTP-C message is not the S11 interface message type, in this case, step S504 is performed.

Step S504. Determine whether a source IP address in the GTP-C message is valid, to determine whether the peer PGW is in a list of roaming operators permitted by an operator to which the SGW belongs.

Optionally, if the source IP address in the GTP-C message is valid, in this case, step S505 is performed.

Optionally, if the source IP address in the GTP-C message is invalid, in this case, step S507 is performed.

Step S505. Determine whether an IMSI is valid.

Optionally, if the IMSI is an IMSI authorized by the PGW, in this case, step S506 is performed.

Optionally, if the IMSI is not an IMSI authorized by the PGW, in this case, step S507 is performed.

Step S506. Determine whether the source IP address is consistent with a source IP address in a GTP-C message received by the SGW or an edge node before the GTP-C message is received.

Optionally, if the source IP address is consistent with the source IP address in the GTP-C message received by the SGW or the edge node before the GTP-C message is received, in this case, step S508 is performed.

Optionally, if the source IP address is inconsistent with the source IP address in the GTP-C message received by the SGW or the edge node before the GTP-C message is received, in this case, step S507 is performed.

Step S507. Determine that the GTP-C message is invalid.

In this embodiment of the present disclosure, in this case, the SGW or the edge node (GTP-C aware) discards the GTP-C message or returns a GTP-C response message carrying an error code.

Step S508. Determine that the GTP-C message is valid.

In this embodiment of the present disclosure, in this case, the SGW or the edge node (GTP-C aware) continues normal service processing.

It should be noted that, the foregoing steps S503, S504, S505, and S506 are optional steps, a sequence between step S503 and step S504 may be exchanged, that is, step S504 may be performed before step S503 is performed, and a sequence between step S502 and step S503 may be exchanged, that is, step S503 may be performed before step S502 is performed.

It can be learned that, in the solution in this embodiment, after the SGW or the edge node receives the GTP-C message sent by the PGW, whether the characteristic parameter carried in the GTP-C message is valid is determined when the GTP-C message is received from the S8 interface, and the GTP-C message is discarded or the GTP-C response message carrying the error code cause value is returned to the PGW when the characteristic parameter is invalid such that a hacker can be effectively prevented from attacking the SGW using each attack path, and communication security is improved.

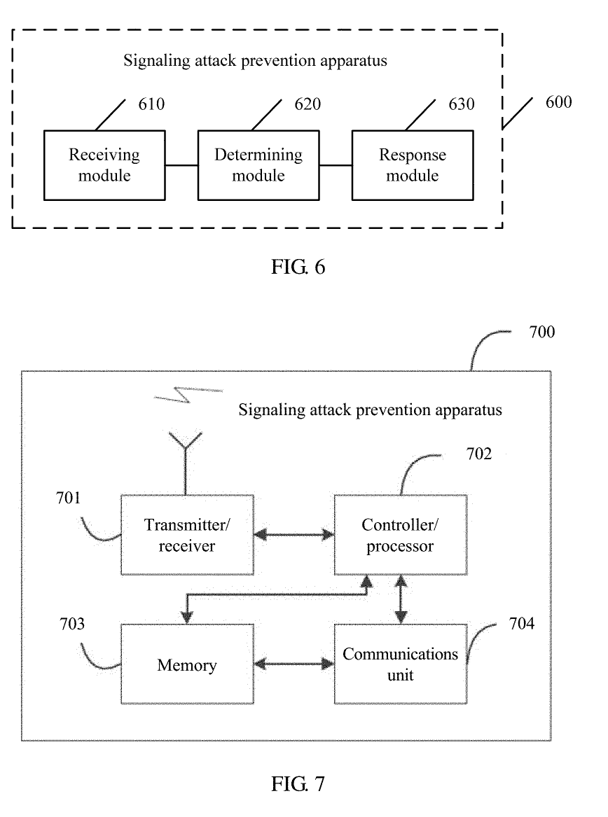

Referring to FIG. 6, FIG. 6 is a schematic structural diagram of a signaling attack prevention apparatus 600 according to an embodiment of the present disclosure. The signaling attack prevention apparatus 600 is configured to implement the signaling attack prevention method disclosed in the embodiments of the present disclosure. As shown in FIG. 6, the signaling attack prevention apparatus 600 provided in this embodiment of the present disclosure may include a receiving module 610, a determining module 620, and a response module 630.

The receiving module 610 is configured to receive a GTP-C message sent by a PGW.

Further, the signaling attack prevention apparatus 600 may be an SGW or an edge node. That is, the GTP-C message sent by the PGW may be received by the SGW, or the GTP-C message sent by the PGW may be received by the edge node (GTP-C aware).

Optionally, the edge node may be a firewall that is deployed at a border of an operator network and that is aware of the GTP-C Protocol.

Further, in this embodiment of the present disclosure, the GTP-C message may be a create bearer request message, a delete session request message, a delete bearer request message, or the like.

Optionally, the GTP-C message may include at least one of the following items a source IP address in the GTP-C message, an IMSI of a user, or a message type of the GTP-C message.

The determining module 620 is configured to determine whether the GTP-C message is received from an S8 interface.

Optionally, in an embodiment of the present disclosure, that the determining module 620 determines whether the GTP-C message is received from an S8 interface includes determining whether the source IP address and an IP address of the SGW or the edge node that receives the GTP-C message belong to a same network segment, and when the source IP address and the IP address of the SGW or the edge node that receives the GTP-C message do not belong to a same network segment, determining that an interface for receiving the GTP-C message is the S8 interface.

Optionally, in another embodiment of the present disclosure, that the determining module 620 determines whether the GTP-C message is received from an S8 interface includes determining whether the source IP address belongs to an IP address set authorized by an operator to which the SGW or the edge node belongs, and when the source IP address does not belong to the IP address set authorized by the operator to which the SGW or the edge node belongs, determining that an interface for receiving the GTP-C message is the S8 interface.

Optionally, the IP address set may be stored in the signaling attack prevention apparatus 600.

Further, the IP address set may be stored in the SGW or the edge node.

The determining module 620 is further configured to, when the GTP-C message is received from the S8 interface, determine whether a characteristic parameter of the GTP-C message is valid.

The response module 630 is configured to, if the characteristic parameter of the GTP-C message is invalid, discard the GTP-C message or return, to the PGW, a GTP-C response message carrying an error code cause value.

Optionally, in an embodiment of the present disclosure, the characteristic parameter includes the message type of the GTP-C message.

That the determining module 620 determines whether the GTP-C message is received from an S8 interface includes determining whether the message type of the GTP-C message is an S11 interface message type, and when the message type of the GTP-C message is the S11 interface message type, determining that the message type of the GTP-C message is invalid.

Optionally, in an embodiment of the present disclosure, the characteristic parameter includes the source IP address in the GTP-C message.

That the determining module 620 determines whether a characteristic parameter of the GTP-C message is valid includes determining whether the source IP address belongs to a preset IP address set, and when the IP address does not belong to the preset IP address set, determining that the source IP address in the GTP-C message is invalid.

Optionally, in an embodiment of the present disclosure, the characteristic parameter includes the source IP address in the GTP-C message.

That the determining module 620 determines whether a characteristic parameter of the GTP-C message is valid includes sending the source IP address to an HSS and/or an MME such that the MME and/or the HSS determine/determines whether the source IP address belongs to the preset IP address set, receiving a home operator determining result returned by the MME and/or the HSS, and when the home operator determining result is that the source IP address does not belong to the preset IP address set, determining that the source IP address in the GTP-C message is invalid.

Optionally, in an embodiment of the present disclosure, the characteristic parameter includes the source IP address in the GTP-C message.

That the determining module 620 determines whether a characteristic parameter of the GTP-C message is valid includes determining whether the source IP address is consistent with a source IP address in a GTP-C message received by the SGW or the edge node before the GTP-C message is received, and when the source IP address is inconsistent with the source IP address in the GTP-C message received by the SGW or the edge node before the GTP-C message is received, determining that the source IP address in the GTP-C message is invalid.

Optionally, in an embodiment of the present disclosure, the characteristic parameter includes the IMSI of the user.

That the determining module 620 determines whether a characteristic parameter of the GTP-C message is valid includes determining whether the IMSI is an IMSI authorized by an operator to which the PGW belongs, and when the IMSI is not the IMSI authorized by the operator to which the PGW belongs, determining that the IMSI in the GTP-C message is invalid.

It can be learned that, in the solution in this embodiment, after the signaling attack prevention apparatus 600 (which is further the SGW or the edge node) receives the GTP-C message sent by the PGW, whether the characteristic parameter carried in the GTP-C message is valid is determined when the GTP-C message is received from the S8 interface, and the GTP-C message is discarded or the GTP-C response message carrying the error code cause value is returned to the PGW when the characteristic parameter is invalid such that a hacker can be effectively prevented from attacking the SGW using each attack path, and communication security is improved.

In this embodiment, the signaling attack prevention apparatus 600 is presented in a form of a unit. The “unit” herein may refer to an application-specific integrated circuit (ASIC), a processor and a memory that execute one or more software or firmware programs, an integrated logic circuit, and/or another component that can provide the foregoing functions.

It may be understood that functions of the function units of the signaling attack prevention apparatus 600 in this embodiment may be implemented according to the methods in the foregoing method embodiments. For a specific implementation process, refer to related descriptions in the foregoing method embodiments, and details are not described herein.

Referring to FIG. 7, FIG. 7 is a schematic structural diagram of another signaling attack prevention apparatus 700 according to an embodiment of the present disclosure. As shown in FIG. 7, the signaling attack prevention apparatus 700 includes a transmitter/receiver 701 and a processor 702. The processor 702 may also be a controller, and is indicated as a “controller/processor 702” in FIG. 7. The transmitter/receiver 701 is configured to support the signaling attack prevention apparatus 700 (which may be an SGW or an edge node) in sending/receiving information to/from the PGW in the foregoing embodiment, and support the SGW in performing radio communication with another device. The processor 702 executes various functions used to communicate with the signaling attack prevention apparatus 700. On an uplink, an uplink signal from the PGW is received using an antenna, is demodulated (for example, a high frequency signal is demodulated into a baseband signal) by the receiver 701, and is then processed by the processor 702 to restore service data and signaling information sent to the signaling attack prevention apparatus 700. On a downlink, the service data and the signaling message are processed by the processor 702, and are modulated (for example, a baseband signal is modulated into a high frequency signal) by the transmitter 701, to generate a downlink signal, and the downlink signal is transmitted to the PGW using the antenna. It should be noted that the foregoing demodulation or modulation function may be implemented by the processor 702. For example, the processor 702 is further configured to perform corresponding steps in the method embodiments, and/or another process in the technical solution described in this embodiment of the present disclosure.

Further, the signaling attack prevention apparatus 700 may further include a memory 703, and the memory 703 is configured to store program code and data of the signaling attack prevention apparatus 700. In addition, the signaling attack prevention apparatus 700 may further include a communications unit 704. The communications unit 704 is configured to support the signaling attack prevention apparatus in communicating with another network entity (for example, a network device in a core network). For example, in a long term evolution (LTE) system, the communications unit 704 may be an S1-MME interface, and be configured to support the signaling attack prevention apparatus in communicating with an MME.

It may be understood that, FIG. 7 shows merely a simplified design of the signaling attack prevention apparatus 700. In actual application, the signaling attack prevention apparatus 700 may include any quantities of transmitters, receivers, processors, controllers, memories, and communications units. All signaling attack prevention apparatuses that can implement the embodiments of the present disclosure fall within the protection scope of the embodiments of the present disclosure.

An embodiment of the present disclosure further provides a computer storage medium. The computer storage medium may store a program, and when the program is executed, some or all steps of any signaling attack prevention method in the foregoing method embodiments are performed.

It should be noted that, to make the description brief, the foregoing method embodiments are expressed as a series of actions. However, persons skilled in the art should appreciate that the present disclosure is not limited to the described action sequence, because according to the present disclosure, some steps may be performed in other sequences or performed simultaneously. In addition, persons skilled in the art should also appreciate that all the embodiments described in the specification are example embodiments, and the related actions and modules are not necessarily mandatory to the present disclosure.

In the foregoing embodiments, the description of each embodiment has respective focuses. For a part that is not described in detail in an embodiment, reference may be made to related descriptions in other embodiments.

In the several embodiments provided in the present disclosure, it should be understood that the disclosed apparatus may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, function units in the embodiments of the present disclosure may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software function unit and sold or used as an independent product, the integrated unit may be stored in a computer-readable storage medium. Based on such an understanding, the technical solutions of the present disclosure essentially, or the part contributing to the other approaches, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a read-only memory (ROM), a random access memory (RAM), a removable hard disk, a magnetic disk, or an optical disc.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present disclosure.

What is claimed is:

1. A signaling attack prevention method, comprising:
receiving a general packet radio service (GPRS) Tunneling Protocol (GTP-C) message from a public data network gateway (PGW), wherein the GTP-C message comprises a characteristic parameter;
determining whether the GTP-C message is received from an eighth data interface (S8);
determining whether the characteristic parameter of the GTP-C message is valid when the GTP-C message is received from the S8; and
discarding the GTP-C message or returning, to the PGW, a GTP-C response message carrying an error code cause value when the characteristic parameter of the GTP-C message is invalid.

2. The signaling attack prevention method of claim 1, wherein the characteristic parameter comprises a message type of the GTP-C message, and wherein determining whether the characteristic parameter of the GTP-C message is valid comprises:
determining whether the message type of the GTP-C message is an eleventh data interface (S11) message type; and
determining that the message type of the GTP-C message is invalid when the message type of the GTP-C message is the S11 message type.

3. The signaling attack prevention method of claim 1, wherein the characteristic parameter comprises a source Internet Protocol (IP) address in the GTP-C message, and wherein determining whether the characteristic parameter of the GTP-C message is valid comprises:
determining whether the source IP address belongs to a preset IP address set; and
determining that the source IP address in the GTP-C message is invalid when the source IP address does not belong to the preset IP address set.

4. The signaling attack prevention method of claim 1, wherein the characteristic parameter comprises a source Internet Protocol (IP) address in the GTP-C message, and wherein determining whether the characteristic parameter of the GTP-C message is valid comprises:
sending the source IP address to a home subscriber server (HSS) and a mobility management entity (MME) to enable the MME and the HSS to determine whether the source IP address belongs to a preset IP address set;
receiving a home operator determining result from the MME and the HSS; and
determining that the source IP address in the GTP-C message is invalid when the home operator determining result is that the source IP address does not belong to the preset IP address set.

5. The signaling attack prevention method of claim 1, wherein the characteristic parameter comprises a source Internet Protocol (IP) address in the GTP-C message, and wherein determining whether the characteristic parameter of the GTP-C message is valid comprises:
sending the source IP address to a home subscriber server (HSS) to enable the HSS to determine whether the source IP address belongs to a preset IP address set;
receiving a home operator determining result from the HSS; and
determining that the source IP address in the GTP-C message is invalid when the home operator determining result is that the source IP address does not belong to the preset IP address set.

6. The signaling attack prevention method of claim 1, wherein the characteristic parameter comprises a source Internet Protocol (IP) address in the GTP-C message, and wherein determining whether the characteristic parameter of the GTP-C message is valid comprises:
sending the source IP address to a mobility management entity (MME) to enable the MME to determine whether the source IP address belongs to a preset IP address set;
receiving a home operator determining result from the MME; and
determining that the source IP address in the GTP-C message is invalid when the home operator determining result is that the source IP address does not belong to the preset IP address set.

7. The signaling attack prevention method of claim 1, wherein the characteristic parameter comprises a source Internet Protocol (IP) address in the GTP-C message, and wherein determining whether the characteristic parameter of the GTP-C message is valid comprises:
determining whether the source IP address is consistent with a second source IP address in a second GTP-C message received by a serving gateway (SGW) or an edge node before the GTP-C message is received; and
determining that the source IP address in the GTP-C message is invalid when the source IP address is inconsistent with the second source IP address in the second GTP-C message received by the SGW or the edge node before the GTP-C message is received.

8. The signaling attack prevention method of claim 1, wherein the characteristic parameter comprises a source Internet Protocol (IP) address in the GTP-C message, and wherein determining whether the GTP-C message is received from the S8 comprises:
determining whether the source IP address and an IP address of a serving gateway (SGW) or an edge node receiving the GTP-C message belong to a same network segment; and
determining that an interface for receiving the GTP-C message is the S8 when the source IP address and the IP address of the SGW or the edge node receiving the GTP-C message do not belong to the same network segment.

9. The signaling attack prevention method of claim 1, wherein the characteristic parameter comprises a source Internet Protocol (IP) address in the GTP-C message, and wherein determining whether the GTP-C message is received from the S8 comprises:
determining whether the source IP address belongs to an IP address set authorized by an operator to which a serving gateway (SGW) or an edge node belongs; and
determining that an interface for receiving the GTP-C message is the S8 when the source IP address does not belong to the IP address set authorized by the operator to which the SGW or the edge node belongs.

10. The signaling attack prevention method of claim 1, wherein the characteristic parameter comprises an international mobile subscriber identity (IMSI) of a user, and wherein determining whether the characteristic parameter of the GTP-C message is valid comprises:
determining whether the IMSI is an IMSI authorized by an operator to which the PGW belongs; and
determining that the IMSI in the GTP-C message is invalid when the IMSI is not the IMSI authorized by the operator to which the PGW belongs.

11. A signaling attack prevention apparatus, comprising:
a receiver configured to receive a general packet radio service (GPRS) Tunneling Protocol (GTP-C) message from a public data network gateway (PGW), wherein the GTP-C message comprises a characteristic parameter; and
a processor coupled to the receiver and configured to:
determine whether the GTP-C message is received from an eighth data interface (S8);
determine whether the characteristic parameter of the GTP-C message is valid when the GTP-C message is received from the S8; and
discard the GTP-C message or return, to the PGW, a GTP-C response message carrying an error code cause value when the characteristic parameter of the GTP-C message is invalid.

12. The signaling attack prevention apparatus of claim 11, wherein the characteristic parameter comprises a message type of the GTP-C message, and wherein in a manner of determining whether the GTP-C message is received from the S8 interface, the processor is further configured to:
determine whether the message type of the GTP-C message is an eleventh data interface (S11) message type; and
determine that the message type of the GTP-C message is invalid when the message type of the GTP-C message is the S11 message type.

13. The signaling attack prevention apparatus of claim 11, wherein the characteristic parameter comprises a source Internet Protocol (IP) address in the GTP-C message, and wherein in a manner of determining whether the characteristic parameter of the GTP-C message is valid, the processor is further configured to:
determine whether the source IP address belongs to a preset IP address set; and
determine that the source IP address in the GTP-C message is invalid when the source IP address does not belong to the preset IP address set.

14. The signaling attack prevention apparatus of claim 11, wherein the characteristic parameter comprises a source Internet Protocol (IP) address in the GTP-C message, and wherein in a manner of determining whether the characteristic parameter of the GTP-C message is valid, the processor is further configured to:
send the source IP address to a home subscriber server (HSS) and a mobility management entity (MME) to enable the MME and the HSS to determine whether the source IP address belongs to a preset IP address set;
receive a home operator determining result from the MME and the HSS; and
determine that the source IP address in the GTP-C message is invalid when the home operator determining result is that the source IP address does not belong to the preset IP address set.

15. The signaling attack prevention apparatus of claim 11, wherein the characteristic parameter comprises a source Internet Protocol (IP) address in the GTP-C message, and wherein in a manner of determining whether the characteristic parameter of the GTP-C message is valid, the processor is further configured to:
send the source IP address to a home subscriber server (HSS) to enable the HSS to determine whether the source IP address belongs to a preset IP address set;
receive a home operator determining result from the HSS; and
determine that the source IP address in the GTP-C message is invalid when the home operator determining result is that the source IP address does not belong to the preset IP address set.

16. The signaling attack prevention apparatus of claim 11, wherein the characteristic parameter comprises a source Internet Protocol (IP) address in the GTP-C message, and wherein in a manner of determining whether the characteristic parameter of the GTP-C message is valid, the processor is further configured to:
send the source IP address to a mobility management entity (MME) to enable the MME to determine whether the source IP address belongs to a preset IP address set;
receive a home operator determining result from the MME; and
determine that the source IP address in the GTP-C message is invalid when the home operator determining result is that the source IP address does not belong to the preset IP address set.

17. The signaling attack prevention apparatus of claim 11, wherein the characteristic parameter comprises a source Internet Protocol (IP) address in the GTP-C message, and wherein in a manner of determining whether the characteristic parameter of the GTP-C message is valid, the processor is further configured to:
determine whether the source IP address is consistent with a second source IP address in a second GTP-C message received by a serving gateway (SGW) or an edge node before the GTP-C message is received; and
determine that the source IP address in the GTP-C message is invalid when the source IP address is inconsistent with the second source IP address in the second GTP-C message received by the SGW or the edge node before the GTP-C message is received.

18. The signaling attack prevention apparatus of claim 11, wherein the characteristic parameter comprises a source Internet Protocol (IP) address in the GTP-C message, and wherein in a manner of determining whether the GTP-C message is received from the S8, the processor is further configured to:
determine whether the source IP address and an IP address of a serving gateway (SGW) or an edge node receiving the GTP-C message belong to a same network segment; and
determine that an interface for receiving the GTP-C message is the S8 when the source IP address and the IP address of the SGW or the edge node receiving the GTP-C message do not belong to the same network segment.

19. The signaling attack prevention apparatus of claim 11, wherein the characteristic parameter comprises a source Internet Protocol (IP) address in the GTP-C message, and wherein in a manner of determining whether the GTP-C message is received from the S8, the processor is further configured to:
determine whether the source IP address belongs to an IP address set authorized by an operator to which a serving gateway (SGW) or an edge node belongs; and
determine that an interface for receiving the GTP-C message is the S8 when the source IP address does not belong to the IP address set authorized by the operator to which the SGW or the edge node belongs.

20. The signaling attack prevention apparatus of claim 11, wherein the characteristic parameter comprises an international mobile subscriber identity (IMSI) of a user, and wherein in a manner of determining whether the characteristic parameter of the GTP-C message is valid, the processor is further configured to:
determine whether the IMSI is an IMSI authorized by an operator to which the PGW belongs; and
determine that the IMSI in the GTP-C message is invalid when the IMSI is not the IMSI authorized by the operator to which the PGW belongs.
